(19) United States
(12) Patent Application Publication
(10) Pub. No.: US 2026/0101424 A1
(43) Pub. Date: Apr. 9, 2026

(54) AUXILIARY LIGHTING SYSTEM AND ASSOCIATED VEHICLE

(71) Applicant: SCOUT MOTORS INC., Tysons, VA (US)

(72) Inventor: Evan Allen, Hazel Park, MI (US)

(21) Appl. No.: 18/908,939

(22) Filed: Oct. 8, 2024

(51) Int. Cl. H05B 45/325; B60Q 1/18; H05B 47/155; H05B 47/17

(52) U.S. Cl. CPC H05B 45/325; B60Q 1/18; H05B 47/155; H05B 47/17

(57) ABSTRACT

An auxiliary lighting system for a vehicle is provided that includes a light assembly comprised of first and second sets of light emitting diodes (LEDs) having different operating voltages. The auxiliary lighting system also includes a switching circuit to operate the light assembly in a respective operating mode responsive to an input voltage. The operating modes include first, second and third operating modes, responsive to the input voltage satisfying first, second and third voltage set points, respectively. In the first operating mode, the first set of LEDs is illuminated and the second set of LEDs is off. In the second operating mode, the first set of LEDs is off and the second set of LEDs is illuminated. In the third operating mode, the first set of LEDs is off and the second set of LEDs is illuminated with greater intensity than in the second operating mode.

### BACKGROUND

Vehicles may include a wide variety of electrically powered accessories. These accessories may be provided at the time of purchase of the vehicle or as an after-market accessory that is purchased to customize a vehicle. Examples of accessories include auxiliary lighting systems, winches, electrical chargers, such as electrical bicycle chargers, and the like.

In order to interface with and control the accessories, a vehicle may include bidirectional communication links with each accessory. Additionally, the vehicle may include a microprocessor or other type of controller for at least some of the accessories in order to separately provide electrical power and control signaling to the accessories. As the number accessories carried by a vehicle increases, the complexity of the control and the number of communication links required by the accessories correspondingly increases. Even with a single accessory, such as an auxiliary lighting system, a number of communication links and more involved control signaling may be required since an auxiliary system may include daytime running lights as well as a main beam which, in turn, can operate in both low and high settings. In this example, each of the daytime running lights, the low setting of the main beam and the high setting of the main beam may require separate control signaling with and electrical power from the vehicle, thereby increasing the cost and complexity associated with the accessory.

### SUMMARY

An auxiliary lighting system and an associated vehicle are provided which have a light assembly and a switching circuit configured to selectively operate the light assembly in different ones of a plurality of operating modes. The switching circuit is configured to operate the light assembly in discrete operating modes based on the relationship of an input voltage to various voltage set points. Thus, the communication between the auxiliary lighting system and the vehicle may be of reduced complexity as the auxiliary lighting system of at least some embodiments does not require bidirectional communication with the vehicle and does not require the provision of control signaling, separate from the electrical power that is provided to the auxiliary lighting system. Moreover, the auxiliary lighting system need not include a controller or other complex control devices. Instead, the switching circuit of the auxiliary lighting system utilizes discrete components that are configured to operate the light assembly in a number of different operating modes while reducing the cost, complexity and package size of the switching circuit.

In an example embodiment, an auxiliary lighting system for a vehicle is provided that includes a light assembly comprised of a first set of light emitting diodes (LEDs) having a first operating voltage and a second set of LEDs having a second operating voltage, different than the first operating voltage. The auxiliary lighting system also includes a switching circuit configured to selectively operate the light assembly in respective ones of a plurality of operating modes responsive to an input voltage. The plurality of operating modes include a first operating mode, responsive to the input voltage satisfying a first voltage set point, in which the first set of LEDs is illuminated and the second set of LEDs is off. The plurality of operating modes also include a second operating mode, responsive to the input voltage satisfying a second voltage set point, in which the first set of LEDs is off and the second set of LEDs is illuminated. The plurality of operating modes further include a third operating mode, responsive to the input voltage satisfying a third voltage set point, greater than the second voltage set point, in which the first set of LEDs is off and the second set of LEDs is illuminated with greater intensity than in the second operating mode.

The switching circuitry of an example embodiment includes a semiconductor switch and a Zener diode configured to receive the input voltage. The semiconductor switch is responsive to operation of the Zener diode to control current to the first set of LEDs and the second set of LEDs of the light assembly. In one embodiment, the semiconductor switch includes an n-type field effect transistor, and the Zener diode has a breakdown voltage that is greater than the first voltage set point and less than the second voltage set point such that the n-type field effect transistor is inactive at the first voltage set point and active at the second voltage set point. In another embodiment, the semiconductor switch comprises a p-type field effect transistor, and the Zener diode has a breakdown voltage that is less than first voltage set point but greater than a voltage drop of the first set of LEDs such that p-type field effect transistor is active at the first voltage set point and inactive at the second voltage set point. In a further embodiment, the semiconductor switch includes a silicon controlled rectifier, and the Zener diode has a breakdown voltage greater than the first voltage set point and less than the second voltage set point such that the silicon controlled rectifier is inactive at the first voltage set point but latches to an active state at the second voltage set point and remains latched in the active state until the input voltage is reduced to a voltage less than a voltage drop of the first set of LEDs.

The light assembly of a certain embodiment further includes a housing with the first set of LEDs, the second set of LEDs, and the switching circuit being enclosed in the housing. In one embodiment, the auxiliary lighting system further includes a connector configured to be in electrical communication with the switching circuit so as to provide the input voltage thereto. In this embodiment, the connector includes only a positive terminal and a negative or a neutral terminal. The switching circuit of one embodiment is responsive to the input voltage in the form of a pulse width modulated (PWM) waveform, and the switching circuit includes a filter configured to smooth the PWM waveform. In this example embodiment, the switching circuit is responsive to the PWM waveform having a duty cycle that is adjusted to define the input voltage. The switching circuit of one embodiment is responsive to the input voltage being received from a controller of a vehicle that carries the auxiliary lighting system.

In another embodiment, an auxiliary lighting system for a vehicle is provided that includes a light assembly comprised of a first set of light emitting diodes (LEDs) having a first operating voltage and a second set of LEDs having a second operating voltage, different than the first operating voltage. The auxiliary lighting system also includes a switching circuit responsive to an input voltage and configured to selectively operate the first set of LEDs and the second set of LEDs. The switching circuit includes a semiconductor switch and a Zener diode configured to receive the input voltage. The auxiliary lighting system further includes a connector configured to be in electrical communication with the switching circuit so as to provide the input voltage thereto. The semiconductor switch is responsive to operation of the Zener diode to control current to the first set of LEDs and the second set of LEDs in order to selectively operate the first set of LEDs and the second set of LEDs in respective ones of a plurality of operating modes. The plurality of operating modes include a first operating mode, responsive to the input voltage satisfying a first voltage set point, in which the first set of LEDs is illuminated and the second set of LEDs is off. The plurality of operating modes also include a second operating mode, responsive to the input voltage satisfying a second voltage set point, in which the first set of LEDs is off and the second set of LEDs is illuminated. The plurality of operating modes further include a third operating mode, responsive to the input voltage satisfying a third voltage set point, greater than the second voltage set point, in which the first set of LEDs is off and the second set of LEDs is illuminated with greater intensity than in the second operating mode.

The semiconductor switch of one embodiment includes an n-type field effect transistor, and the Zener diode has a breakdown voltage that is greater than the first voltage set point and less than the second voltage set point such that the n-type field effect transistor is inactive at the first voltage set point and active at the second voltage set point. The n-type field effect transistor may be in parallel with the first set of LEDs. In another embodiment, the semiconductor switch includes a p-type field effect transistor, and the Zener diode has a breakdown voltage that is less than first voltage set point but greater than a voltage drop of the first set of LEDs such that p-type field effect transistor is active at the first voltage set point and inactive at the second voltage set point. In a further embodiment, the semiconductor switch includes a silicon controlled rectifier, and the Zener diode has a breakdown voltage greater than the first voltage set point and less than the second voltage set point such that the silicon controlled rectifier is inactive at the first voltage set point but latches to an active state at the second voltage set point and remains latched in the active state until the input voltage is reduced to a voltage less than a voltage drop of the first set of LEDs. The silicon controlled rectifier may be in parallel with the first set of LEDs. The controller of one embodiment includes only a positive terminal and a negative or a neutral terminal.

A vehicle includes a vehicle body and a light assembly carried by the vehicle body. The light assembly includes a first set of light emitting diodes (LEDs) having a first operating voltage and a second set of LEDs having a second operating voltage, different than the first operating voltage. The vehicle also includes a switching circuit configured to selectively operate the light assembly in respective ones of a plurality of operating modes responsive to an input voltage. The plurality of operating modes include a first operating mode, responsive to the input voltage satisfying a first voltage set point, in which the first set of LEDs is illuminated and the second set of LEDs is off. The plurality of operating modes also include a second operating mode, responsive to the input voltage satisfying a second voltage set point, in which the first set of LEDs is off and the second set of LEDs is illuminated. The plurality of operating modes further include a third operating mode, responsive to the input voltage satisfying a third voltage set point, greater than the second voltage set point, in which the first set of LEDs is off and the second set of LEDs is illuminated with greater intensity than in the second operating mode.

The vehicle of one embodiment also includes a controller configured to provide an input voltage, wherein the input voltage comprises a pulse width modulated (PWM) waveform. In one embodiment, the vehicle of Claim 19 further includes a connector configured to be in electrical communication with the switching circuit and the controller so as to provide the input voltage to the switching circuit. The connector of an example embodiment includes only a positive terminal and a negative or a neutral terminal.

### BRIEF DESCRIPTION OF THE DRAWINGS

Having thus described some embodiments of the present disclosure in general terms, reference will hereinafter be made to the accompanying drawings, which are not necessarily drawn to scale, and wherein:

FIG. 1 is a perspective view of a vehicle including an auxiliary lighting system;

FIG. 2 is a perspective view of the auxiliary lighting system of FIG. 1;

FIG. 3 is a block diagram of an auxiliary lighting system in accordance with an example embodiment in communication with a controller of a vehicle on which the auxiliary lighting system is mounted;

FIG. 4 is a circuit diagram of a switching circuit in accordance with an example embodiment of the present disclosure;

FIG. 5 is a circuit diagram of a switching circuit in accordance with another example embodiment of the present disclosure;

FIG. 6 is a circuit diagram of a switching circuit in accordance with a further example embodiment of the present disclosure; and

FIG. 7 is a flow chart illustrating operations performed in order to automatically recognize the auxiliary lighting system of an example embodiment of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

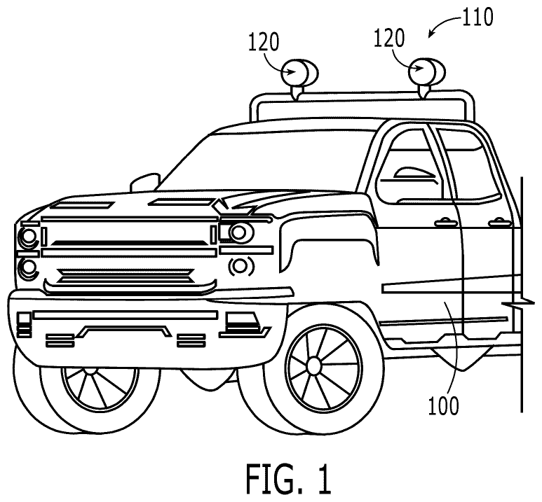

An auxiliary lighting system is provided in accordance with an example embodiment of the present disclosure. The auxiliary lighting system is configured to be carried by a vehicle 100, such as the body of the vehicle, such as shown in FIG. 1. Although the vehicle 100 depicted in FIG. 1 is a truck, a variety of different types of vehicles can be configured to carry the auxiliary lighting system 110 including a sport utility vehicle, an automobile or the like. The auxiliary lighting system 110 includes one or more light assemblies 120 that are in addition to the lights mandated for street legal operation of the vehicle 100. Thus, the auxiliary lighting system 110 includes lights in addition to the headlights and taillights of the vehicle 100 and generally provides for external illumination of the vehicle and its surroundings.

The auxiliary lighting system 110 of the embodiment of FIG. 1 is mounted upon the roof of the vehicle 100 and is positioned to illuminate a region forward of the vehicle. However, the auxiliary lighting system 110 may be mounted upon other portions of the vehicle 100 and may be differently directed so as to illuminate different regions relative to the vehicle, such as by illuminating a region rearward of the vehicle. In another example, the auxiliary lighting system may be mounted on a front bumper or the front grill of the vehicle to provide additional forward illumination that may supplement the illumination provided by the vehicle headlights.

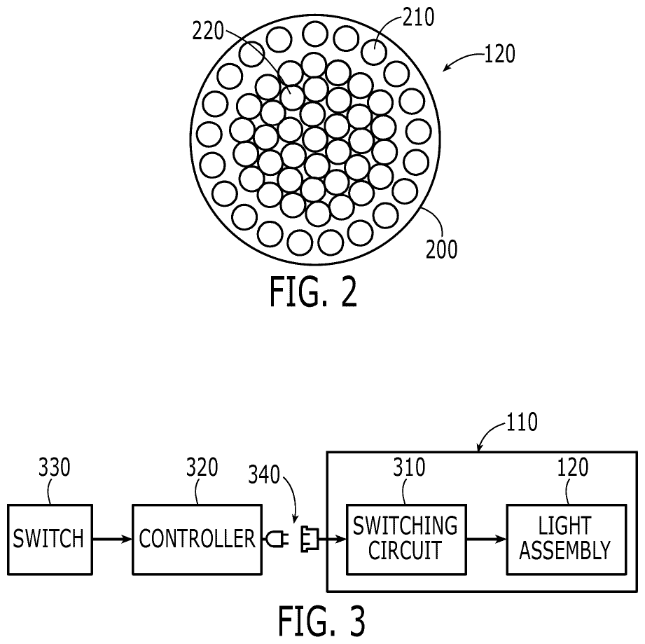

Referring now to FIG. 2, the light assembly 120 of an auxiliary lighting system 110 of an example embodiment is depicted. In this example, the light assembly 120 is configured to be carried by the vehicle body of a vehicle 100 and includes a first set of lighting emitting diodes (LEDs) 210 having a first operating voltage and therefore configured to generate light having a first color. The light assembly 120 also includes a second set of LEDs 220 having a separating operating voltage, different than the first operating voltage. Thus, the second set of LEDs 220 is configured to generate light of a second color, different than the first color that is generated by the first set of LEDs 210. Although the first and second sets of LEDs may have various colors, the first set of LEDs 210 of one example provides illumination of a yellow color, while the second set of LEDs 220 provides illumination of a white color.

The light assembly 120 of an example embodiment also includes a housing 200 that encloses the first and second sets of LEDs 210, 220 in such a manner that the illumination generated by the first and second sets of LEDs is visible exterior of the housing. In the example embodiment, the housing 200 of the light assembly 120 has a circular cross-sectional shape with the first and second sets of LEDs 210, 220 positioned concentrically therein. In this regard, the first set of LEDs 210 may be disposed as a circular ring around the second set of LEDs 220. However, the light assembly 120 may have any of a wide variety of other shapes including, for example, rectangularly shaped light assemblies, and the first and second sets of LEDs 210, 220 may be differently positioned relative to one another within the housing 200. Additionally, while the light assembly 120 of this example embodiment includes first and second sets of LEDs 210, 220, the light assembly may include additional sets of LEDs such as a third set of LEDs, a fourth set of LEDs or the like in other example embodiments with the additional set(s) of LEDs having the same or different operating voltages and therefore generating light of the same or different color than either of the first or second sets of LEDs.

In addition to the light assembly 120, the auxiliary lighting system 110 of an example embodiment includes a switching circuit 310 configured to selectively operate the light assembly in respective ones of a plurality of operating modes responsive to, that is, dependent upon an input voltage. Although the switching circuit 310 may be external to the housing 200 while remaining in communication with the light assembly 120, the switching circuit of an example embodiment is embodied within the housing along with the first and second sets of LEDs 210, 220. Referring now to FIG. 3, a block diagram of an auxiliary lighting system 110 in communication with a vehicle 100 that carries the auxiliary lighting system is depicted. As shown in FIG. 3 and as will be described below, a vehicle 100, such as a controller 320 onboard the vehicle, is in communication with the switching circuit 310 and is configured to selectively provide the input voltage to the switching circuit 310 indicating the respective operating mode in which the light assembly 120 is to operate. The controller 320 may be implemented in numerous different ways but, in some implementations, may be a lighting controller for the vehicle 100, e.g., a form of electronic control unit (ECU). The switching circuit 310 is also in communication with the light assembly 120 and is configured to selectively operate the first set of LEDs 210 and/or the second set of LEDs 220 depending upon the operating mode in which the light assembly is to operate.

In certain embodiments, input is provided to the controller 320 by the driver or passenger of the vehicle 100 to indicate whether the light assembly 120 is to be activated and, if so, the mode of operation of the light assembly. Although the input may be provided in various manners, the auxiliary lighting system 110 of the illustrated embodiment includes a switch 330 onboard the vehicle 100 via which the user provides input to the controller 320. In one embodiment, the switch 330 is a rotary knob that is operable by the driver or passenger of the vehicle 100 and serves to provide an input voltage to both activate the lighting assembly 120 and to identify the operating mode in which the lighting assembly is to operate. In other example embodiments, the switch 330 may include a bank of switches, each associated with a different operating mode, or switch 330 may instead be a digital user interface of the vehicle 100. For example, the vehicle 100 may have a touchscreen display, e.g., an “infotainment” display, through which an occupant of the vehicle 100 can activate and/or otherwise control the auxiliary lighting system 110.

As to the plurality of operating modes of the auxiliary lighting system 110, the first operating mode is responsive to the input voltage satisfying a first voltage set point, but not second and third voltage set points described below. In the first operating mode, the first set of LEDs 210 is illuminated and the second set of LEDs 220 is off, e.g., inactive, so as not to be illuminated. The second operating mode is responsive to the input voltage satisfying the second voltage set point, but not the third voltage set point. The second voltage set point is greater than the first voltage set point. In the second operating mode, the first set of LEDs 210 is off so as not to be illuminated and the second set of LEDs 220 is illuminated. The third operating mode is responsive to the input voltage satisfying a third voltage set point, greater than the second voltage set point. In the third operating mode, the first set of LEDs 210 is off so as not to be illuminated and the second set of LEDs 220 is illuminated with greater intensity than in the second operating mode. Although the auxiliary lighting system 110 may be utilized in a variety of applications, the plurality of operating modes permits the first set of LEDs 210 to serve as daytime running lights and the second set of LEDs 220 to serve as a main beam. In this embodiment, the daytime running lights are illuminated, but not the main beam in the first operating mode. In the second and third operating modes, the main beam is illuminated in a low setting and a high setting, respectively, but the daytime running lights are no longer activated in either the second or third operating modes.

The first, second and third operating modes are mutually exclusive such that the light assembly 120 operates in a single operating mode at a time. For example, in an embodiment in which the third voltage set point is greater than the second voltage set point and the second voltage set point is greater than the first voltage set point, the light assembly 120 operates in accordance with the operating mode having the greatest voltage set point that is satisfied. Thus, in an instance in which the input voltage satisfies the second voltage set point, but not the third voltage set point, the light assembly 120 operates in the second operating mode, but not the first operating mode even though the first voltage set point is also satisfied concurrent with the satisfaction of the second voltage set point. Similarly, in an instance in which the input voltage satisfies the third voltage set point, the light assembly 120 operates in accordance with the third operating mode, but not the first and second operating modes even though the first and second voltage set points are also concurrently satisfied by the satisfaction of the third voltage set point.

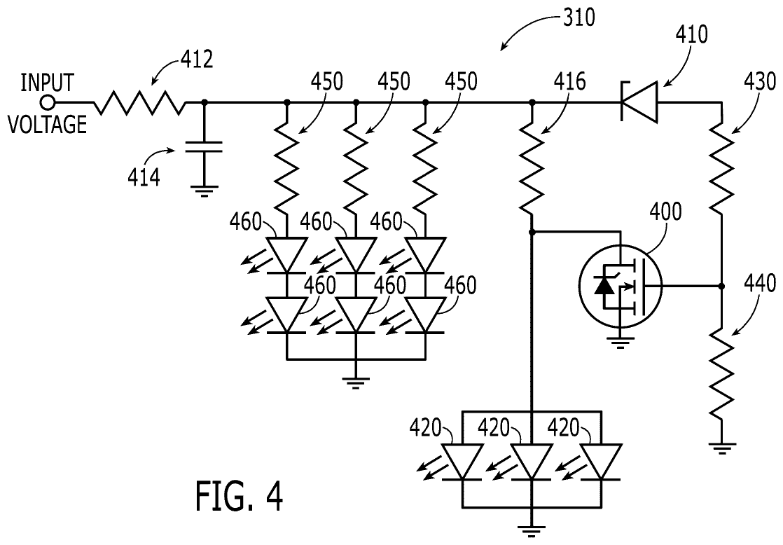

The switching circuit 310 may be configured in various manners. In one embodiment, the switching circuit 310 includes a semiconductor switch and a Zener diode configured to receive the input voltage. The semiconductor switch of this embodiment is controlled responsive to operation of the Zener diode to control current to and, as a result, operation of, the first set of LEDs 210 and the second set of LEDs 220 of the light assembly 120. One example of this type of switching circuit 310 is depicted in FIG. 4 in which the semiconductor switch 400 comprises a n-type field effect transistor (FET). The switching circuit 310 of this example includes an input via which the input voltage is received from the vehicle 100, such as from the controller 320 based on input provided by the switch 330. The switching circuit 310 may include a filter, such as a low pass filter, configured to smooth the input signal. Although the filter may be configured in different manners, the filter of the illustrated embodiment includes a resistor 412 in line with the input and a capacitor 414 connecting the output of the resistor to ground.

In certain embodiments, the input voltage has a pulse width modulated (PWM) waveform and the filter of the switching circuit 310 is configured to smooth the PWM waveform. As such, the switching circuit 310 is responsive to the PWM waveform, which has a duty cycle that is controllably adjusted by the vehicle 100, such as by the controller 320, to define the input voltage.

As shown in FIG. 4, the switching circuit 310 not only includes a semiconductor switch 400, such as an n-type field effect transistor positioned in parallel with the first set of LEDs 420 in the illustrated embodiment, and a Zener diode 410, but also a plurality of other resistors. As described in more detail below, the switching circuit 310 of this embodiment includes a current limiting resistor 416 connected to the drain of the n-type field effect transistor 400 and to the first set of LEDs 420, a pair of resistors 430, 440 configured to define the voltage at the gate of the n-type field effect transistor, and current limiting resistors 450 connected to the second set of LEDs 460.

The switching circuit 310 of the embodiment of FIG. 4 operates in accordance with four set points including the first, second and third voltage set points described above. Although the input voltage levels associated with each of the set points may be differently valued in other embodiments, the switching circuit 310 of the embodiment of FIG. 4 has set point 0 of 0 volts, set point 1 of 4 volts, set point 2 of 8 volts, and set point 3 of 12 volts. The first voltage set point, that is set point 1, has a voltage level that is less than the voltage drop across the second set of LEDs 460 and is also less than the breakdown voltage of the Zener diode 410, but is greater than the voltage drop across the first set of LEDs 420. As shown in the embodiment of FIG. 4, the second set of LEDs 460 may include two or more LEDs in series such that the voltage drop across the second set of LEDs is greater than the voltage drop of the first set of LEDs and is also greater than set point 1. As also shown in FIG. 4, one or both of the first and second sets of LEDs 420, 460 can include a plurality of LEDs in parallel. Although FIG. 4 depicts three parallel LED arrangements, the first and/or the second sets of LEDs 420, 460 may include any number of parallel LED arrangements and the first and second sets of LEDs may include the same or different numbers of parallel LED arrangements.

In the example of FIG. 4, the second voltage set point, that is, set point 2, has a voltage level that is greater than the breakdown voltage of the Zener diode 410 and also greater than the voltage drops across the first set of LEDs 420 and the second set of LEDs 460. Further, the third voltage set point, that is, set point 3, has a voltage level that is greater than the voltage levels of set points 0, 1 and 2 and, as a result, is also greater than the breakdown voltage of the Zener diode 410 and the voltage drops across the first set of LEDs 420 and the second set of LEDs 460.

In this example embodiment, at set point 0 at which the input voltage is 0 volts, the first and second LEDs 420, 460 are off so as not to provide illumination. At the first voltage set point at which the input voltage is 4 volts, the switching circuit 310 is in the first operating mode in which the first set of LEDs 420 are illuminated and the second set of LEDs 460 are off. In this regard, the input voltage of 4 volts is insufficient to activate the second set of LEDs 460, which has a voltage drop of greater than 4 volts as a result of having two or more LEDs in series. Similarly, the Zener diode 410 remains open in response to an input voltage of 4 volts since the breakdown voltage of the Zener diode is greater than 4 volts, such as 5.1 volts in one example. As the Zener diode 410 is open and does not conduct current in response to an input voltage of 4 volts, the gate of the semiconductor switch 400, that is, the n-type field effect transistor, is grounded, such that the semiconductor switch is not active. As such, the input voltage in the first operating mode causes current to flow through the current limiting resistor 416 and then activates the first set of LEDs 420, which, in one embodiment have a voltage drop of about 2.2 volts, so as provide illumination of a yellow color.

At the second voltage set point at which the input voltage is 8 volts, the switching circuit 310 is in the second operating mode in which the first set of LEDs 420 is off and the second set of LEDs 460 is illuminated. In response to the input voltage of 8 volts, the Zener diode 410 is activated and begins to conduct current due to the input voltage exceeding the breakdown voltage of the Zener diode 410. The resistors 430, 440 downstream of the Zener diode split the voltage in order to control the voltage applied to the gate of the n-type field effect transistor. In one embodiment, resistor 440 may be several orders of magnitude larger than resistor 430 such that the majority of the voltage downstream of the Zener diode 410 is applied to the gate of the n-type field effect transistor. In response, the n-type field effect transistor is activated so as to conduct current which causes the drain of the n-type field effect transistor to have a voltage approximately equal to the voltage drop, e.g., 0.7 volts, across the n-type field effect transistor. As a result of the parallel arrangement of the semiconductor switch 400 and the first set of LEDs 420 and also as a result of the voltage at the drain of the n-type field effect transistor being less than the voltage drop across the first set of LEDs, the first set of LEDs turn off so as to no longer be illuminated.

Instead, since the input voltage of 8 volts is greater than the voltage drop across the second set of LEDs 460 (more than 4 volts, but less than 8 volts in this example), the input voltage causes current to flow through the current limiting resistors 450 and the second set of LEDs 460, thereby causing the second set of LEDs to be illuminated which, in one embodiment, generates white light. In one embodiment, the current limiting resistors 450 upstream of the second set of LEDs 460 are the same size such that the same current flows through each of the parallel LED arrangements in order to cause all of the second set of LEDs to be illuminated in the same manner with the same intensity. In an alternative embodiment in which the intensity of the second set of LEDs 460 is to vary in a predefined manner such that some of the second set of LEDs are illuminated with more intensity than others of the second set of LEDs, the current limiting resistors 450 have different values. In this embodiment, the LEDs of the second set of LEDs 460 through which greater current flows (as a result of being downstream of a smaller current limiting resistor 450) would be illuminated with a greater intensity than other LEDs of the second set of LEDs through which a smaller current flows (as a result of being downstream of a larger current limiting resistor).

Finally, at the third voltage set point at which the input voltage is 12 volts, the switching circuit 310 is in the third operating mode in which the first set of LEDs 420 remains off so as not to be illuminated and the second set of LEDs 460 remains illuminated, but with a greater intensity than exhibited by the second set of LEDs in the second operating mode. The increased intensity of the illumination provided by the second set of LEDs 460 is attributable to the larger input voltage causing more current to flow through the second set of LEDs in the third operating mode than in the second operating mode.

Although not depicted in FIG. 4, the switching circuit 310 may also include a capacitor connected to the gate of the n-type field effect transistor. Adding a capacitor to the gate of the n-type field effect transistor would cause the first set of LEDs 420, once illuminated at the first voltage set point, to remain illuminated temporarily once the input voltage changes to a different voltage set point, thereby potentially smoothing the visible effect of the transition from the first voltage set point to any of the other voltage set points.

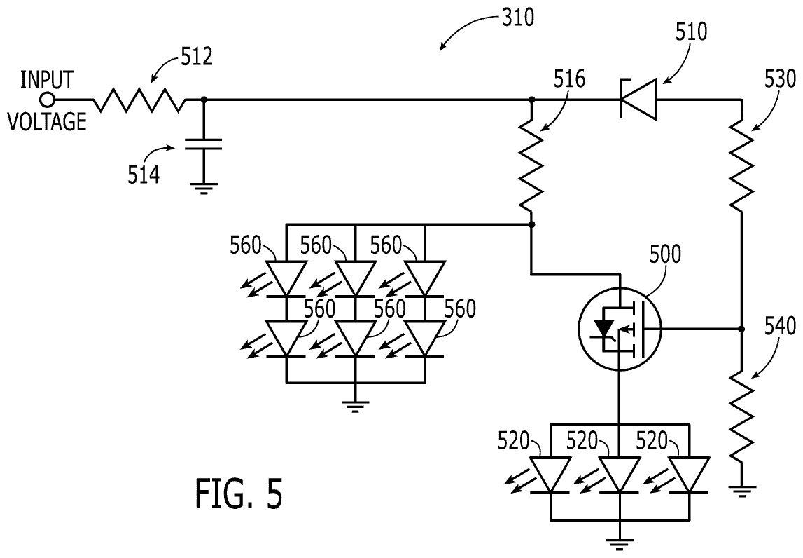

Another example of a switching circuit 310 is depicted in FIG. 5 in which the semiconductor switch 500 comprises a p-type field effect transistor. As described above, the switching circuit 310 of this example includes an input via which the input voltage, such as a PWM waveform, is received from the vehicle 100, such as from the controller 320 based on input provided by the switch 330. The switching circuit 310 may also include a filter, such as a low pass filter, configured to smooth the input signal. Although the filter may be configured in different manners, the filter of the illustrated embodiment includes a resistor 512 in line with the input and a capacitor 514 connecting the output of the resistor to ground.

As shown in FIG. 5, the switching circuit 310 not only includes a semiconductor switch 500, such as a p-type field effect transistor, and a Zener diode 510, but also a plurality of other resistors. As described in more detail below, the switching circuit 310 of this embodiment includes a current limiting resistor 516 connected to the drain of the p-type field effect transistor 500 and to the second set of LEDs 560, and a pair of resistors 530, 540 configured to define the voltage at the gate of the p-type field effect transistor.

The switching circuit 310 of the embodiment of FIG. 5 operates in accordance with four set points including the first, second and third voltage set points described above. Although the input voltage levels associated with each of the set points may be differently valued in other embodiments, the switching circuit 310 of the embodiment of FIG. 5 also has set point 0 of 0 volts, set point 1 of 4 volts, set point 2 of 8 volts, and set point 3 of 12 volts. The first voltage set point, that is set point 1, has a voltage level that is less than the voltage drop across the second set of LEDs 560, but is greater than both the breakdown voltage of the Zener diode 510 and greater than the voltage drop across the first set of LEDs 520. In other words, the Zener diode 510 has a breakdown voltage that is less than first voltage set point, but greater than a voltage drop of the first set of LEDs 520.

In the example of FIG. 5, the second voltage set point, that is, set point 2, has a voltage level that is greater than the breakdown voltage of the Zener diode 510 and also greater than the voltage drops across the first set of LEDs 520 and the second set of LEDs 560. Further, the third voltage set point, that is, set point 3, has a voltage level that is greater than the voltage levels of set points 0, 1 and 2 and, as a result, is also greater than the breakdown voltage of the Zener diode 510 and the voltage drops across the first set of LEDs 520 and the second set of LEDs 560.

In this example embodiment, at set point 0 at which the input voltage is 0 volts, the first and second LEDs 520, 560 are off so as not to provide illumination. At the first voltage set point at which the input voltage is 4 volts, the switching circuit 310 is in the first operating mode in which the first set of LEDs 520 are illuminated and the second set of LEDs 560 are off. In this regard, the input voltage of 4 volts is insufficient to activate the second set of LEDs 560, which has a voltage drop of greater than 4 volts as a result of having two or more LEDs in series and/or due to the second set of LEDs 560 otherwise being configured to have a turn-on voltage greater than the first voltage set point. However, the Zener diode 510 is activated so as to conduct current in response to an input voltage of 4 volts since the breakdown voltage of the Zener diode in this embodiment is less than 4 volts, such as 3.9 volts in one example. As the Zener diode 510 is conductive in the first operating mode, the voltage downstream of the Zener diode (such as 0.1 volts in an instance in which the input voltage is 4 volts and the breakdown voltage of the Zener diode is 3.9 volts) is divided by resistors 530, 540 in order to control the voltage applied to the gate of the p-type field effect transistor. In one embodiment, resistor 540 may be several orders of magnitude larger than resistor 530 such that the majority of the voltage downstream of the Zener diode 510 is applied to the gate of the p-type field effect transistor.

In this embodiment, the voltage drop across the first set of LEDs 520 and the semiconductor switch 500 are such that the breakdown voltage of the Zener diode 510 is greater than the voltage drop across the current limiting resistor 516 at the first voltage set point. As a result of the voltage at the drain of the p-type field effect transistor exceeding the voltage at the gate, the p-type field effect transistor is activated and current flows through the first set of LEDs 520, thereby causing the first set of LEDs to be illuminated, such as with a yellow color.

At the second voltage set point at which the input voltage is 8 volts, the switching circuit 310 is in the second operating mode in which the first set of LEDs 520 is off and the second set of LEDs 560 is illuminated. In response to the input voltage of 8 volts that exceeds the breakdown voltage of the Zener diode 510, the Zener diode 510 is activated and begins to conduct current and the resistors 530, 540 downstream of the Zener diode split the voltage in order to control the voltage applied to the gate of the p-type field effect transistor. As resistor 540 has a resistance that is substantially larger than the resistance of resistor 530, the voltage at the gate of the p-type field effect transistor is approximately 4 volts at the second voltage set point. In contrast, if current were to flow through the semiconductor switch 500 and the first set of LEDs 520, the voltage at the drain of the p-type field effect transistor would be approximately 3 volts as a result of a voltage drop of 2.2 volts across the first set of LEDs 520 and a voltage drop of 0.7 volts across the p-type field effect transistor. As the voltage at the drain of the p-type field effect transistor is less than the voltage at the gate, the p-type field effect transistor is inactive such that no current flows therethrough and the first set of LEDs 520 turn off so as to no longer be illuminated. As a result and also as a result of the input voltage at the second voltage set point exceeding the voltage drop across the second set of LEDs 560 (more than 4 volts, but less than 8 volts in this example), the input voltage causes current to flow through the current limiting resistor 516 and the second set of LEDs 560, thereby causing the second set of LEDs to be illuminated which, in one embodiment, generates white light. Although a single current limiting resistor 516 upstream of the second set of LEDs 560 is depicted in FIG. 5, the switching circuit 310 of another embodiment may include a plurality of current limiting resistors electrically connected to different ones of the parallel LED arrangements of the second set of LEDs, such as shown in FIG. 4. In an instance in which the plurality of current limiting resistors have different resistance values, the LEDs of the second set of LEDs 560 may be illuminated with different intensities, as also described above.

Finally, at the third voltage set point at which the input voltage is 12 volts, the switching circuit 310 is in the third operating mode in which the first set of LEDs 520 remains off so as not to be illuminated and the second set of LEDs 560 remains illuminated, but with a greater intensity than exhibited by the second set of LEDs in the second operating mode. The increased intensity of the illumination provided by the second set of LEDs 560 is attributable to the larger input voltage causing more current to flow through the second set of LEDs in the third operating mode than in the second operating mode.

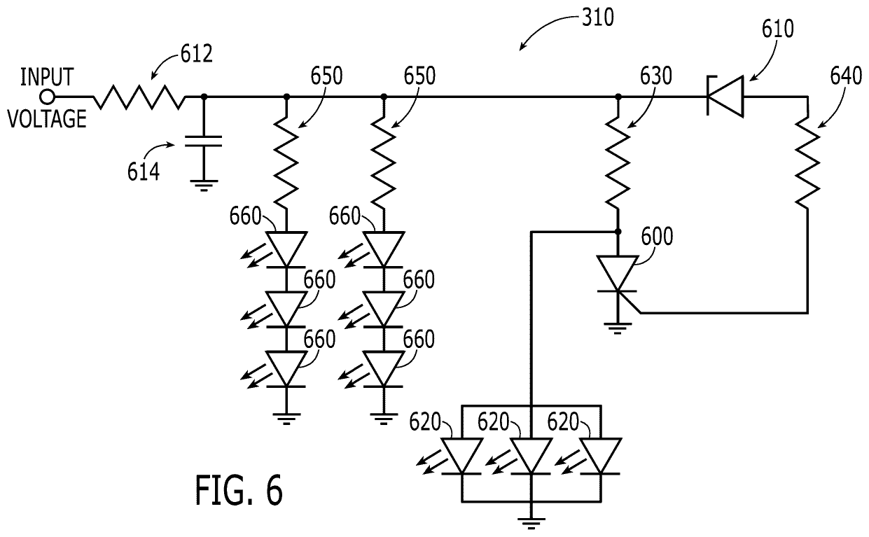

A further example of a switching circuit 310 is depicted in FIG. 6 in which the semiconductor switch 600 comprises a silicon controlled rectifier (SCR). As described above, the switching circuit 310 of this example includes an input via which the input voltage, such as a PWM waveform, is received from the vehicle 100, such as from the controller 320 based on input provided by the switch 330. The switching circuit 310 may also include a filter, such as a low pass filter, configured to smooth the input signal. Although the filter may be configured in different manners, the filter of the illustrated embodiment includes a resistor 612 in line with the input and a capacitor 614 connecting the output of the resistor to ground.

As shown in FIG. 6, the switching circuit 310 not only includes a semiconductor switch 600, such as an SCR, in parallel with the first set of LEDs 620 and a Zener diode 610, but also a plurality of other resistors. As described in more detail below, the switching circuit 310 of this embodiment includes a current limiting resistor 630 connected to the anode of the SCR 600 and also to the first set of LEDs 620, a current limiting resistor 640 connected to the gate of the SCR and one or more current limiting resistors 650 connected to the second set of LEDs 660.

The switching circuit 310 of the embodiment of FIG. 6 operates in accordance with four set points. Although the input voltage levels associated with each of the set points may be differently valued in other embodiments, the switching circuit 310 of the embodiment of FIG. 6 has set point 0 of 0 volts, set point 1 of 7 volts, set point 2 of 9 volts, and set point 3 of 12 volts. The first voltage set point, that is set point 1, has a voltage level that is less than the voltage drop across the second set of LEDs 660 and is also less than the breakdown voltage of the Zener diode 610, but that is greater than the voltage drop across the first set of LEDs 620.

In the example of FIG. 6, the second voltage set point, that is, set point 2, has a voltage level that is greater than the breakdown voltage of the Zener diode 610 and also greater than the voltage drops across the first set of LEDs 620 and the second set of LEDs 660. Further, the third voltage set point, that is, set point 3, has a voltage level that is greater than the voltage levels of set points 0, 1 and 2 and, as a result, is also greater than the breakdown voltage of the Zener diode 610 and the voltage drops across the first set of LEDs 620 and the second set of LEDs 660.

In this example embodiment, at set point 0 at which the input voltage is 0 volts, the first and second LEDs 620, 660 are off so as not to provide illumination. At the first voltage set point at which the input voltage is 7 volts, the switching circuit 310 is in the first operating mode in which the first set of LEDs 620 are illuminated and the second set of LEDs 660 are off. In this regard, the input voltage of 7 volts is insufficient to activate the second set of LEDs 660, which has a voltage drop of greater than 7 volts as a result of having three or more LEDs in series. Additionally, since the breakdown voltage of the Zener diode 610 of this embodiment is greater than the input voltage of 7 volts, the Zener diode 510 is inactivate and does not conduct current such that the SCR is also inactive. However, the input voltage of 7 volts exceeds the voltage drop across the first set of LEDs 620 such that current flows through the current limiting resistor 630 and the first set of LEDs in order to cause the first set of LEDs to be illuminated, thereby generating yellow light in one embodiment.

At the second voltage set point at which the input voltage is 9 volts, the switching circuit 310 is in the second operating mode in which the first set of LEDs 620 is off and the second set of LEDs 660 is illuminated. In response to the input voltage of 9 volts, the Zener diode 610 is activated and begins to conduct current since the breakdown voltage of the Zener diode is greater than 7 volts, but less than 9 volts. As such, current flows through current limiting resistor 640 to the gate of the SCR In this regard, the input voltage at the second voltage set point, the breakdown voltage of the Zener diode and the resistance of the current limiting resistor 640 are selected such that sufficient current is provided to the gate of the SCR in the second operating mode to latch the SCR into a conductive state. As a result of the parallel configuration of the SCR and the first set of LEDs 620, once the SCR is activated so as to be conductive, the first set of LEDs becomes inactive so as to no longer be illuminated. However, the input voltage at the second voltage set point exceeds the voltage drop across the second set of LEDs 660 such that the second set of LEDs is activated and current flows therethrough, thereby causing the second set of LEDs to be illuminated which, in one embodiment, generates white light. Although each parallel arrangement of LEDs of the second set of LEDs 660 is electrically connected to a different resistor 650, the switching circuit 310 of another embodiment may include a single resistor connected to all of the parallel LED arrangements of the second set of LEDs, such as shown in FIG. 5. The current limiting resistors 650 may have the same resistance values or different resistance values and, in an instance in which the plurality of current limiting resistors have different resistance values, the LEDs of the second set of LEDs 660 may be illuminated with different intensities, as also described above.

Finally, at the third voltage set point at which the input voltage is 12 volts, the switching circuit 310 is in the third operating mode in which the first set of LEDs 620 remains off so as not to be illuminated and the second set of LEDs 660 remains illuminated, but with a greater intensity than exhibited by the second set of LEDs in the second operating mode. The increased intensity of the illumination provided by the second set of LEDs 660 is attributable to the larger input voltage causing more current to flow through the second set of LEDs.

In the embodiment of FIG. 6, the Zener diode 610 has a breakdown voltage greater than the first voltage set point, but less than the second and third voltage set points. As such, the SCR is inactive at the first voltage set point, but latches to an active state in which current is conducted therethrough at the second voltage set point. The SCR then remains latched in the active state until the input voltage is reduced to a voltage that is less than a voltage drop of the first set of LEDs 620, thereby avoiding reillumination of the first set of LEDs in an instance in which the switch is returned to set point 0 by being sequentially advanced from set point 3 to set point 2 and then set point 1 prior to reaching set point 0.

As described above in relation to the embodiments of FIGS. 4-6, one example of a switching circuit 310 includes four voltage set points defining different operating modes. In other embodiments, the switching circuit 310 may define a different number of voltage set points, such as five or more voltage set points defining additional operating modes. For example, one or more additional voltage set points may be defined between the input voltage levels of the second voltage set point and the third voltage set point, thereby allowing the second set of LEDs 460, 560, 660 to be illuminated with different predefined levels of intensity. Alternatively, in the embodiment of FIG. 4, one or more additional voltage set points may be defined at a voltage level greater than the voltage level associated with the first voltage set point, but less than the breakdown voltage level of the Zener diode 410, thereby allowing the first set of LEDs 420 to be illuminated at different predefined levels of intensity.

As described, input voltages at the discrete voltage levels associated with the different set points are provided by the vehicle 100, such as by a controller 320 of the vehicle. For example, the vehicle 100 may include a switch 330, such as a rotary switch, having four predefined positions with each position associated with a different voltage level set point and therefore a different operating mode of the switching circuit. Alternatively, the vehicle 100 may be configured to provide an input voltage that may be varied continuously, such that the voltage is capable of being swept from 0 volts to 12 volts while passing through each of the different voltage set points. In either embodiment, the input voltage may be provided by a single voltage source, such as a single 12 volt voltage source.

In the embodiment described above, a single input that provides the input voltage not only provides the voltage necessary for operation of the auxiliary lighting system 110, but also effectively provides the control signaling to indicate the respective one of a plurality of operating modes in which the auxiliary lighting system is to operate. In this regard, the voltage level of the input voltage relative to the different predefined voltage threshold set points provides the control necessary to indicate the particular operating mode. The switching circuit 310 and the light assembly 120 can therefore be electrically connected to the remainder of the vehicle 100, such as the controller 320 by a single circuit, such as provided by a single connector 340 having only a positive terminal and a negative or a neutral terminal as shown in FIG. 3 to allow connection of a single circuity having only two wires, namely, a positive wire and a negative or neutral wire. As such, the amount of wiring that must be dedicated to the auxiliary light system 110 can be reduced. Moreover, as input voltage defines the operating mode, the switching circuit 310 and the light assembly 120 need not include a processor, a controller, or the like in order to interpret the control signals provided by the controller. Instead, the switching circuit 310 of the auxiliary lighting system 110 utilizes discrete components as described above in relation to the embodiments of FIGS. 4-6 that are configured to operate the light assembly 120 in a number of different operating modes while reducing the cost, complexity and package size of the switching circuit.

In certain embodiments, the auxiliary lighting system 110 is configured to be automatically recognized by the vehicle 100, such as a controller 320 of the vehicle, once the auxiliary lighting system is connected to the vehicle. For example, the auxiliary lighting system 110 may be recognized once the connector of the auxiliary lighting system is electrically connected to respective terminals of the controller 320 of the vehicle 100. As such, the auxiliary lighting system 110 may mounted to the vehicle 100 and then plugged into an electrical wiring system of the vehicle such that the auxiliary lighting system may be automatically recognized, such as by the controller 320 of the vehicle. Once recognized, the vehicle 100, such as the controller 320, may be configured to receive user input, such as via a switch 330, as to the desired operating mode and an appropriate input voltage may then be provided to the switching circuit 310.

The auxiliary lighting system 110 may be recognized in various manners, such as described by U.S. patent application Ser. No. 18/614,261 filed Mar. 22, 2024, the contents of which are incorporated herein by reference. In one example, however, the vehicle 100, such as the controller 320 is configured to detect that an auxiliary lighting system 110 has been electrically connected to the vehicle, such as by being plugged into a port of the vehicle. The vehicle 100, such as the controller 320, may be configured to detect the auxiliary lighting system 110 by measuring or otherwise obtaining a measure the resistance presented by the auxiliary lighting system 110 upon electrical connection to the vehicle. In one embodiment, the vehicle 100, such as the controller 320, is also configured to cause a prompt to be presented to a user, such as by presenting a display upon the human machine interface (HMI) of the vehicle, permitting user input of one or more attributes of the auxiliary lighting system 110. For example, a prompt may be displayed indicating that the auxiliary lighting system 110 has been detected and that permits the use to define the functionality of the auxiliary lighting system, such as by providing an indication that the auxiliary lighting system has daytime running light functionality. The vehicle 100, such as the controller 320, may then be configured to interact with and control the auxiliary lighting system 110 based on the user input defining its functionality.

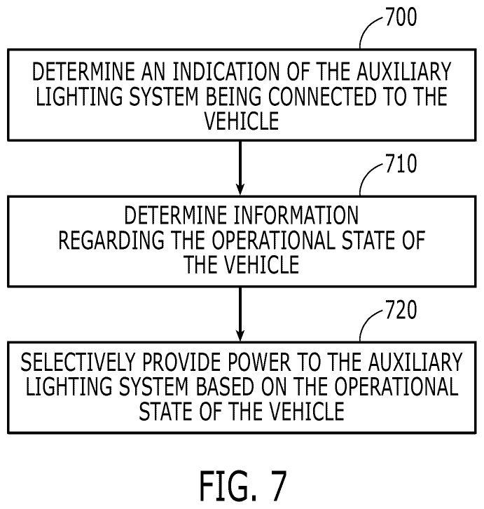

Regardless of the manner in which the auxiliary lighting system 110 is recognized, the controller 320 is configured to determine an indication of the auxiliary lighting system being connected to the vehicle 100 as shown in block 700 of FIG. 7, such as by receiving an indication from another device or detecting the auxiliary lighting system itself. In addition to detecting the presence of the auxiliary lighting system 110, the controller 320 of the vehicle 100 may also be configured to determine if one or more predefined conditions relating to the operational state of the vehicle are satisfied for the auxiliary lighting system to be operable (and for the input voltage to be provided to the switching circuit 310 in a manner defined by the manually actuated switch 330 carried by the vehicle). As such, the controller 320 may be configured to determine information regarding the operational state of the vehicle, such as by receiving the information from another device, such as from another controller, or by making the determination itself. See block 710 of FIG. 7. Based on the operational state of the vehicle and the desired operating mode, the controller 320 is configured to selectively provide power to the auxiliary lighting system 110. See block 720 of FIG. 7. In one embodiment, the desired operating mode may be provided by user input, such as by user placement of the switch 330 in a position corresponding to the desired operating mode. Alternatively, the vehicle 100, such as the controller 320, may be configured to automatically determine the operating mode. For example, in this alternative embodiment, the vehicle 100, such as the controller 320, may determine whether the headlights are illuminated or are off and then define the desired operating mode to correspond to the state of the headlights as described below. In this example, the controller 320 may be configured to determine the state of the headlights as a result of the controller also operating the headlights. Alternative, the controller 320 may be configured to receive information regarding the state of the headlights from another device, such as a separate headlight controller.

By way of example, in an embodiment described above, the first set of LEDs 420, 520, 620 having a yellow color may be configured to serve as additional daytime running lights. Daytime running lights are activated in an instance in which the headlights are off and not illuminated. Thus, the controller 320 of a vehicle 100 may be configured to determine if the headlights are illuminated or are off. If the headlights are determined to be off, the first set of LEDs 420, 520, 620 of the auxiliary lighting system 110 are allowed to be activated once the switch 330 is placed in the position associated with the first voltage set point. However, if the headlights are determined to be illuminated, the controller 320 of this embodiment may render the first set of LEDs 420, 520, 620 inoperable regardless of the input provided via the switch 330, such as by not providing an input voltage even if the switch is placed in a positioned associated with the first operating mode.

In this embodiment, the second set of LEDs 460, 560, 660 that are capable of being illuminated to provide white light can be activated in an instance in which the vehicle 100 is in an offroad mode. As such, the controller 320 of the vehicle 100 is configured to monitor the mode of the vehicle and in an instance in which the mode of the vehicle is set to be the offroad mode, the second set of LEDs 460, 560, 660 are permitted to be activated. While in the offroad mode, if the switch 330 is placed in a position associated with the second or third operating modes of the auxiliary lighting system 110, the controller 320 provides the corresponding input voltage to the switching circuit 310 in order to activate the second set of LEDs 460, 560, 660. However, if the vehicle is not in the offroad mode, the controller 320 of this embodiment may render the second set of LEDs 460, 560, 660 inoperable regardless of the input provided via the switch 330, such as by not providing the requisite input voltage even if the switch is placed in a position associated with the second or third operating modes. As such, while a user may provide manual input identifying the operating mode and, in turn, the input voltage that is requested to be provided to the switching circuit 310, such as by manually positioning the switch 330 in a position associated with one of the first, second or third set points, the overall availability and operation of the auxiliary lighting system 110 may be automatically controlled based on predefined conditions monitored by the controller 320 of the vehicle 100, such as whether the headlights are activated and/or whether the vehicle is in an offroad mode.

Although the foregoing descriptions and the associated drawings describe some embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An auxiliary lighting system for a vehicle, the auxiliary lighting system comprising:
a light assembly comprised of a first set of light emitting diodes (LEDs) having a first operating voltage and a second set of LEDs having a second operating voltage, different than the first operating voltage; and
a switching circuit configured to selectively operate the light assembly in respective ones of a plurality of operating modes responsive to an input voltage, wherein the plurality of operating modes comprise:
a first operating mode, responsive to the input voltage satisfying a first voltage set point, in which the first set of LEDs is illuminated and the second set of LEDs is off;
a second operating mode, responsive to the input voltage satisfying a second voltage set point, in which the first set of LEDs is off and the second set of LEDs is illuminated; and
a third operating mode, responsive to the input voltage satisfying a third voltage set point, greater than the second voltage set point, in which the first set of LEDs is off and the second set of LEDs is illuminated with greater intensity than in the second operating mode.

2. The auxiliary lighting system of claim 1, wherein the switching circuit comprises:
a semiconductor switch; and
a Zener diode configured to receive the input voltage,
wherein the semiconductor switch is responsive to operation of the Zener diode to control current to the first set of LEDs and the second set of LEDs of the light assembly.

3. The auxiliary lighting system of claim 2, wherein the semiconductor switch comprises an n-type field effect transistor, and wherein the Zener diode has a breakdown voltage that is greater than the first voltage set point and less than the second voltage set point such that the n-type field effect transistor is inactive at the first voltage set point and active at the second voltage set point.

4. The auxiliary lighting system of claim 2, wherein the semiconductor switch comprises a p-type field effect transistor, and wherein the Zener diode has a breakdown voltage that is less than first voltage set point but greater than a voltage drop of the first set of LEDs such that p-type field effect transistor is active at the first voltage set point and inactive at the second voltage set point.

5. The auxiliary lighting system of claim 2, wherein the semiconductor switch comprises a silicon controlled rectifier, and wherein the Zener diode has a breakdown voltage greater than the first voltage set point and less than the second voltage set point such that the silicon controlled rectifier is inactive at the first voltage set point but latches to an active state at the second voltage set point and remains latched in the active state until the input voltage is reduced to a voltage less than a voltage drop of the first set of LEDs.

6. The auxiliary lighting system of claim 1, wherein the light assembly further comprises a housing, wherein the first set of LEDs, the second set of LEDs, and the switching circuit are enclosed in the housing.

7. The auxiliary lighting system of claim 1, further comprising a connector configured to be in electrical communication with the switching circuit so as to provide the input voltage thereto, wherein the connector comprises only a positive terminal and a negative or a neutral terminal.

8. The auxiliary lighting system of claim 1, wherein the switching circuit is responsive to the input voltage comprising a pulse width modulated (PWM) waveform, and wherein the switching circuit comprises a filter configured to smooth the PWM waveform.

9. The auxiliary lighting system of claim 8, wherein the switching circuit is responsive to the PWM waveform having a duty cycle that is adjusted to define the input voltage.

10. The auxiliary lighting system of claim 1, wherein the switching circuit is responsive to the input voltage being received from a controller of a vehicle that carries the auxiliary lighting system.

11. An auxiliary lighting system for a vehicle, the auxiliary lighting system comprising:
a light assembly comprised of a first set of light emitting diodes (LEDs) having a first operating voltage and a second set of LEDs having a second operating voltage, different than the first operating voltage;
a switching circuit responsive to an input voltage and configured to selectively operate the first set of LEDs and the second set of LEDs, wherein the switching circuit comprises:
a semiconductor switch; and
a Zener diode configured to receive the input voltage; and
a connector configured to be in electrical communication with the switching circuit so as to provide the input voltage thereto,
wherein the semiconductor switch is responsive to operation of the Zener diode to control current to the first set of LEDs and the second set of LEDs in order to selectively operate the first set of LEDs and the second set of LEDs in respective ones of a plurality of operating modes, and wherein the plurality of operating modes comprise:
a first operating mode, responsive to the input voltage satisfying a first voltage set point, in which the first set of LEDs is illuminated and the second set of LEDs is off;
a second operating mode, responsive to the input voltage satisfying a second voltage set point, in which the first set of LEDs is off and the second set of LEDs is illuminated; and
a third operating mode, responsive to the input voltage satisfying a third voltage set point, greater than the second voltage set point, in which the first set of LEDs is off and the second set of LEDs is illuminated with greater intensity than in the second operating mode.

12. The auxiliary lighting system of claim 11, wherein the semiconductor switch comprises an n-type field effect transistor, and wherein the Zener diode has a breakdown voltage that is greater than the first voltage set point and less than the second voltage set point such that the n-type field effect transistor is inactive at the first voltage set point and active at the second voltage set point.

13. The auxiliary lighting system of claim 12, wherein the n-type field effect transistor is in parallel with the first set of LEDs.

14. The auxiliary lighting system of claim 11, wherein the semiconductor switch comprises a p-type field effect transistor, and wherein the Zener diode has a breakdown voltage that is less than first voltage set point but greater than a voltage drop of the first set of LEDs such that p-type field effect transistor is active at the first voltage set point and inactive at the second voltage set point.

15. The auxiliary lighting system of claim 11, wherein the semiconductor switch comprises a silicon controlled rectifier, and wherein the Zener diode has a breakdown voltage greater than the first voltage set point and less than the second voltage set point such that the silicon controlled rectifier is inactive at the first voltage set point but latches to an active state at the second voltage set point and remains latched in the active state until the input voltage is reduced to a voltage less than a voltage drop of the first set of LEDs.

16. The auxiliary lighting system of claim 15, wherein the silicon controlled rectifier is in parallel with the first set of LEDs.

17. The auxiliary lighting system of claim 11, wherein the controller comprises only a positive terminal and a negative or a neutral terminal.

18. A vehicle comprising:
a vehicle body;
a light assembly carried by the vehicle body, the light assembly comprising a first set of light emitting diodes (LEDs) having a first operating voltage and a second set of LEDs having a second operating voltage, different than the first operating voltage; and
a switching circuit configured to selectively operate the light assembly in respective ones of a plurality of operating modes responsive to an input voltage, wherein the plurality of operating modes comprise:
a first operating mode, responsive to the input voltage satisfying a first voltage set point, in which the first set of LEDs is illuminated and the second set of LEDs is off;
a second operating mode, responsive to the input voltage satisfying a second voltage set point, in which the first set of LEDs is off and the second set of LEDs is illuminated; and
a third operating mode, responsive to the input voltage satisfying a third voltage set point, greater than the second voltage set point, in which the first set of LEDs is off and the second set of LEDs is illuminated with greater intensity than in the second operating mode.

19. The vehicle of claim 18, further comprising a controller configured to provide an input voltage, wherein the input voltage comprises a pulse width modulated (PWM) waveform.

20. The vehicle of claim 19, further comprising a connector configured to be in electrical communication with the switching circuit and the controller so as to provide the input voltage to the switching circuit, wherein the connector comprises only a positive terminal and a negative or a neutral terminal.
